(19) United States
(12) Patent Application Publication
(10) Pub. No.: US 2015/0346886 A1
(43) Pub. Date: Dec. 3, 2015

(54) ELECTRONIC DEVICE, METHOD AND COMPUTER READABLE MEDIUM

(71) Applicant: KABUSHIKI KAISHA TOSHIBA, Tokyo (JP)

(72) Inventor: Shigeru Motoi, Kokubunji Tokyo (JP)

(21) Appl. No.: 14/601,461

(22) Filed: Jan. 21, 2015

(30) Foreign Application Priority Data
May 28, 2014 (JP) 2014-110329

(51) Int. Cl. G06F 3/041; G06K 9/00; G06F 3/0354

(52) U.S. Cl. CPC G06F 3/0412; G06F 3/03546; G06K 9/00865; G06F 2203/04104; G06F 2203/04108

(57) ABSTRACT

According to one embodiment, a method of an electronic device capable of stylus input executes first processing when a stylus is rotated by more than a first angle in a first direction on an axis of the stylus in a state where an end portion of the stylus is in contact with or in proximity to a display surface of a display.

### CROSS-REFERENCE TO RELATED APPLICATIONS

This application is based upon and claims the benefit of priority from Japanese Patent Application No. 2014-110329, filed May 28, 2014, the entire contents of which are incorporated herein by reference.

### FIELD

Embodiments described herein relate generally to an electronic device capable of stylus input.

### BACKGROUND

Recently, computers with a digitizer incorporated in a display portion have been developed. These devices are capable not only of input by means of a keyboard and a mouse but also of input by a touch operation with a stylus. For example, while a menu is displayed on the screen, any of the items on the menu is touched with the stylus, and thus, a menu item is selected.

Conventional electronic devices incorporating a digitizer detect a touch operation on the screen to generate an event, thereby inputting data. In stylus operations, other than the touch operation, there is a rotation operation or the like. Conventionally, however, the operations other than the touch operation have not been used for data input.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an example of an external appearance of an electronic device of an embodiment.

FIG. 2 is a block diagram showing an example of a cooperative operation of a tablet computer 10 with an external apparatus.

FIG. 3 is an exemplary view of handwritten characters handwritten on a touch screen display 17 with a stylus 100.

FIG. 4 illustrates time-series data 200 corresponding to the handwritten characters of FIG. 3.

FIG. 5 is a block diagram showing an example of a system configuration of the tablet computer 10.

FIG. 6 is an exemplary view of a note preview screen image of a digital note produced using a digital note application program 202.

FIGS. 7A and 7B show an exemplary view of a rotating operation of the stylus 100 used as an event generation trigger.

FIG. 8 is a flowchart showing an example of a setting of an initial angle necessary for rotation detection.

FIG. 9 is a flowchart showing an example of the rotation detection.

FIGS. 10A, 10B, 10C and 10D show another exemplary view of the rotating operation of the stylus 100 used as the event generation trigger.

FIG. 11 is a flowchart showing an example of the rotation detection of FIGS. 10A-10D.

FIG. 12 is a flowchart continued from the flowchart of FIG. 11.

FIG. 13 is a flowchart showing an example of processing of a digital note application responding to stylus rotation detection.

FIG. 14 is a flowchart for a modified example of the flowchart of FIG. 9.

FIG. 15 is a flowchart for a modified example of the flowchart of FIG. 12.

### DETAILED DESCRIPTION

Various embodiments will be described hereinafter with reference to the accompanying drawings.

In general, according to one embodiment, a method of an electronic device capable of stylus input executes first processing when a stylus is rotated by more than a first angle in a first direction on an axis of the stylus in a state where an end portion of the stylus is in contact with or in proximity to a display surface of a display.

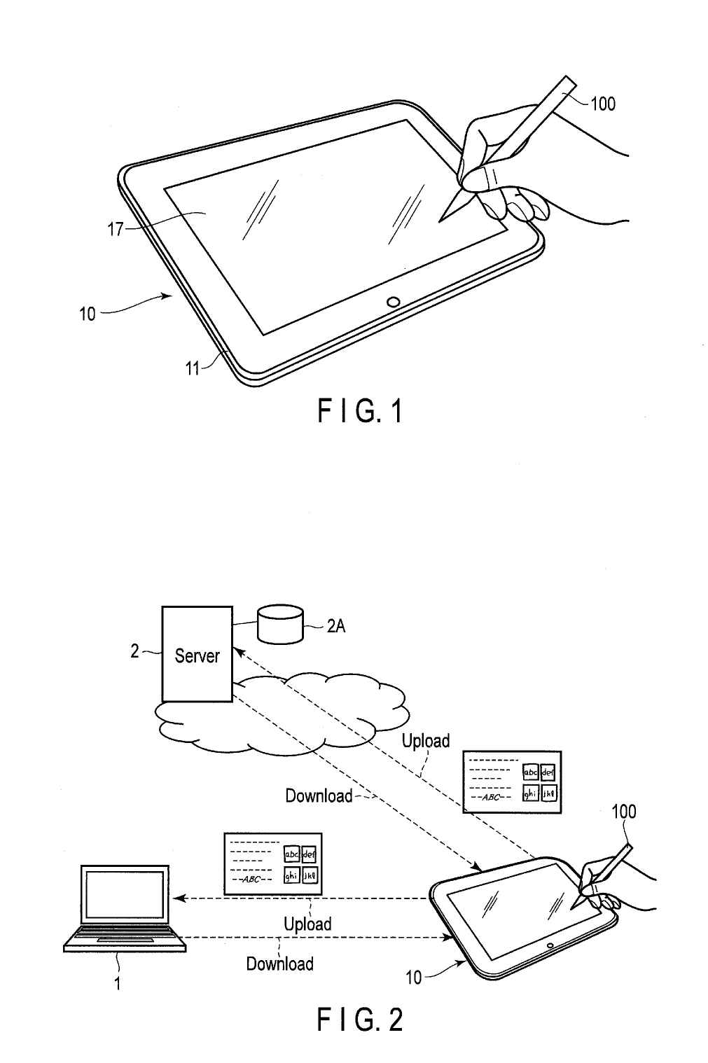

FIG. 1 is a perspective view of an external appearance of an electronic device of an embodiment. The electronic device may be realized as a tablet computer, a notebook computer, a smartphone, a PDA or the like. A tablet computer is also called a tablet or a slate computer. The following descriptions are presented given that the electronic device is realized as a tablet computer 10 capable of handwriting input with a stylus or a finger. However, the electronic device only needs to be capable of a touch operation with a stylus and not necessarily be capable of handwritten character input with a stylus or a touch input with a finger. FIG. 1 illustrates the way the tablet computer 10 is used in the horizontal orientation, but since the tablet computer 10 includes a triaxial acceleration sensor and is configured to detect the inclination of the device and rotate a displayed image based on the detection, the tablet computer 10 can be used in the vertically orientation as well.

The tablet computer 10 includes a body 11 and a touch screen display 17. The body 11 includes a thin box-shaped housing. The touch screen display 17 is overlaid on the upper surface of the body 11. The touch screen display 17 incorporates a flat panel display and a sensor. The sensor is configured to detect a contact position with a stylus 100 or a finger on the screen of the flat panel display.

The flat panel display is, for example, a liquid crystal display (LCD) device. As the sensor, for example, a capacitive touch panel, an electromagnetic induction digitizer or the like can be used. Here, both of these two kinds of sensors, namely, a digitizer and a touch panel are incorporated into the touch screen display 17. However, the touch panel may be omitted.

The digitizer is provided, for example, below the screen of the flat panel display. The touch panel is provided, for example, on the screen of the flat panel display. Therefore, the touch screen display 17 can detect not only a touch operation with a finger on the screen but also a touch operation with the stylus 100 on the screen.

The stylus 100 may be, for example, an electromagnetic induction digitizer stylus. Note that, even when an electromagnetic induction digitizer stylus is not in contact with the screen, if the tip of the stylus is in proximity to the screen, the sensor can detect the position of the tip of the stylus (position in the x-y plane) by electromagnetic induction.

The user can perform stylus input and character handwriting on the touch screen display 17 with an external object (stylus 100 or finger). During a stylus input operation, when the position of the tip of a stylus is detected, the data corresponding to the position is input. During handwriting input operation, the locus of the movement an external object (stylus 100 or finger) on the screen, that is, the locus of a stroke input by hand is rendered in real time, and in this way, the locus of each stroke is displayed on the screen. The locus of the movement of an external object while the external object is in contact with the screen corresponds to one stroke. The collection of a number of strokes corresponding to a handwritten character, a figure or the like, that is, a collection of a number of loci constitutes a handwritten document.

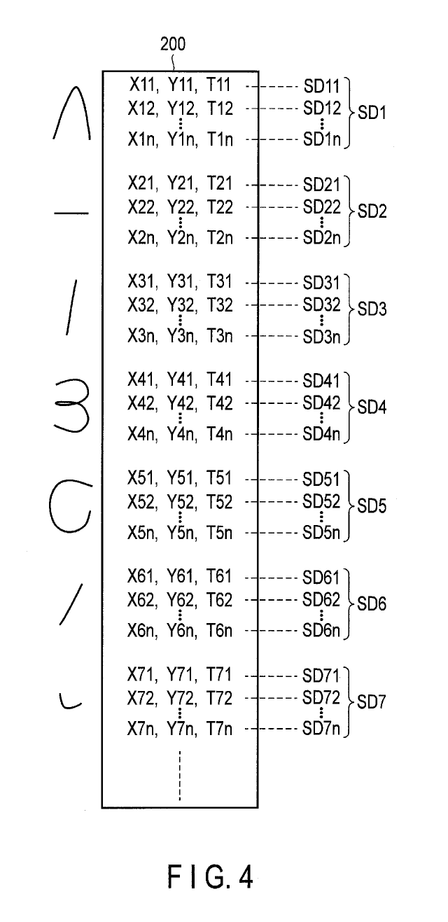

The handwritten document is stored in a storage medium not as image data but as time-series data indicative of the coordinate sequence of the locus of each stroke and the order relationship between strokes. The time-series data, which will be described later in detail with reference to FIG. 4, includes a plurality of items of stroke data corresponding to respective plurality of strokes and indicative of the order in which the plurality of strokes are handwritten. In other words, the time-series data is a collection of items of time-series stroke data correspond to a plurality of respective strokes. Each item of stroke data corresponds to a certain stroke and includes a series of items of coordinate data (time-series coordinates) corresponding to respective points on the locus of the stroke. The sequence of these items of the stroke data corresponds to the order in which respective strokes are handwritten, namely, the stroke order.

The tablet computer 10 can retrieve from the storage medium any time-series data which has already been stored therein to display on the screen a handwritten document corresponding to the time-series data, namely, strokes corresponding to a plurality of items of stroke data indicated by the time-series data. Further, the tablet computer 10 includes an editing function. The editing function is capable of deleting or displacing any stroke, handwritten character or the like in a currently displayed handwritten document based on an editing operation by the user with an eraser tool, a selection tool and various other tools. Still further, the editing function includes a function of deleting a history of several handwriting operations.

The stylus for handwriting can change the pen type (such as pencil, mechanical pencil, ball-point pen, fountain pen or felt pen), the line color, the line thickness and the line transparency, and thus these changes, which can also be made by the user setting beforehand, can be made as one of the editing functions even after handwriting is performed.

FIG. 2 illustrates an example of a cooperative operation of the tablet computer 10 with an external apparatus. The tablet computer 10 can cooperate with a personal computer 1 or a cloud computing system. That is, the tablet computer 10 includes a wireless communication device such as a wireless LAN and is capable of performing a wireless communication with the personal computer 1. Further, the tablet computer 10 can establish a communication with a server 2 on the internet. The server 2 may be a server performing an online storage service and various other cloud computing services.

The personal computer 1 includes a storage device such as a hard disk drive (HDD). The tablet computer 10 is capable of transmitting time-series data (handwritten document) to the personal computer 1 over a network to store it in the HDD of the personal computer 1 (upload).

In this way, even when the capacity of the storage of the tablet computer 10 is small, the tablet computer 10 can handle a large number items of time-series data (handwritten documents) or a large volume of time-series data (handwritten documents).

Further, the tablet computer 10 can retrieve any one or more handwritten documents stored in the HDD of the personal computer 1 (download). The tablet computer 10 can display the loci of respective strokes indicated by the retrieved handwritten documents on the screen of the touch screen display 17 of the tablet computer 10. In this case, a list of thumbnails obtained by reducing the sizes of the respective pages of the handwritten documents may be displayed on the screen of the touch screen display 17 or a single page selected from these thumbnails may be displayed on the screen of the touch screen display 17 in the standard size.

Still further, the correspondent of the communication with the tablet computer 10 may not be the personal computer 1 but may be the server 2 in the cloud computing system for providing a storage service or the like as described above. The tablet computer 10 can transmit a handwritten document to the server 2 over a network to store it in a storage device 2A of the server 2 (upload). Further, the tablet computer 10 can retrieve any handwritten document stored in the storage device 2A of the server 2 (download). The tablet computer 10 can display loci of respective strokes indicated by the retrieved handwritten document on the screen of the touch screen display 17.

As described above, the storage medium storing a handwritten document may be any of a storage device in the tablet computer 10, a storage device in the personal computer 1 and a storage device of the server 2.

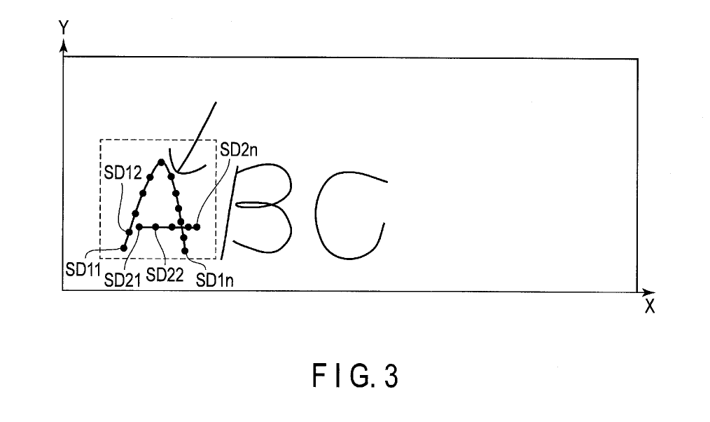

Next, with reference to FIGS. 3 and 4, the relationship between a stroke (character, mark, figure, diagram, table, etc.,) handwritten by the user and a handwritten document will be described. FIG. 3 illustrates an example of handwritten characters handwritten with the stylus 100 or the like on the touch screen display 17.

In handwritten documents, there are many cases where, on a character, figure, etc., having already been handwritten, another character, figure, etc., is further handwritten. In FIG. 3, a case where handwritten characters “ABC” is handwritten in the order of A, B and C, and a handwritten arrow is then handwritten in immediate proximity to the handwritten character “A” is described.

The handwritten character “A” is represented by two strokes made with the stylus 100 or the like (locus in the form of “A” and locus in the form of “-”), that is, by two loci. The locus of the stylus 100 in the form of “A” made first is, for example, sampled at equal time intervals in real time, and thus time-series coordinates of the “A” stroke SD11, SD12, SD1n are obtained. Similarly, the locus of the stylus 100 in the form of the “-” stroke made next is sampled at equal time intervals in real time, and thus time-series coordinates of the “-” stroke SD21, SD22, SD2n are obtained.

The handwritten character “B” is presented by two strokes made with the stylus 100 or the like, namely, by two loci. The handwritten character “C” is represented by one stroke made with the stylus 100 or the like, namely, by one locus. The handwritten “arrow” is presented by two handwritten strokes made with the stylus 100 or the like, namely, by two loci.

FIG. 4 illustrates time-series data 200 corresponding to the handwritten characters of FIG. 3. The time-series data 200 includes a plurality of items of stroke data SD1, SD2, SD7. In the time-series data 200, these items of stroke data SD1, SD2, SD7 are listed in the stroke order, that is, in the order in which the strokes are handwritten, namely, in chronological order.

In the time-series data 200, the first two items of stroke data SD1 and SD2 indicate two strokes of the handwritten character “A”, respectively. The third and fourth items of stroke data SD3 and SD4 indicate two strokes constituting the handwritten character “B”, respectively. The fifth item of stroke data SD5 indicates one stroke constituting the handwritten character “C”. The sixth and seventh items of stroke data SD6 and SD7 indicate two strokes constituting the handwritten “arrow”, respectively.

Each item of stroke data includes a series of items of coordinate data (time-series coordinates) corresponding to one stroke, that is, a plurality of coordinates corresponding to respective points on the locus of one stroke. In each item of stroke data, coordinates are listed in the order in which the stroke is handwritten, namely, in chronological order. For example, as for the handwritten character “A”, the item of stroke data SD1 includes a series of items of coordinate data (time-series coordinates) corresponding to the respective points on the locus of the “A” stroke of the handwritten character “A”, namely, n items of coordinates data SD11, SD12, . . . , SD1n. The item of stroke data SD2 includes a series of items of coordinate data corresponding to the respective points on the locus of the “-” stroke of the handwritten character “A”, namely, n items of coordinates data SD21, SD22, SD2n. Note that the number of items of coordinate data may vary from item of stroke data to item of stroke data. That is, the locus of the stylus 100 is sampled at equal time intervals in real time, and therefore as a stroke becomes longer or a stroke is made more slowly, the number of items of its coordinate data increases.

Each item of coordinate data indicates an x-coordinate and a y-coordinate corresponding to a certain point on a corresponding locus. For example, the item of coordinate data SD11 indicates the x-coordinate X11 and the y-coordinate Y11 of the starting point of the “A” stroke. SD1n indicates the x-coordinate X1n and the y-coordinate Y1n of the end point of the “A” stroke.

Further, each item of coordinate data may include timestamp data T corresponding to a point in time when a point corresponding to the coordinates is handwritten. Still further, to each item of coordinate data, data indicative of writing pressure Z may be added. The writing pressure data is detected by the stylus 100 and transmitted from the stylus 100 to the touch screen display 17. It is possible to write a character expressively by changing the thickness of the line based on the writing pressure.

Still further, in the present embodiment, as described above, a handwritten document is stored not as an image or a recognition result of characters but as a collection of items of time-series stroke data, and therefore it is possible to handle a handwritten document regardless of the language of the handwritten characters. Consequently, the structure of the time-series data 200 of the present embodiment can be commonly used in various countries around the world in which different languages are used.

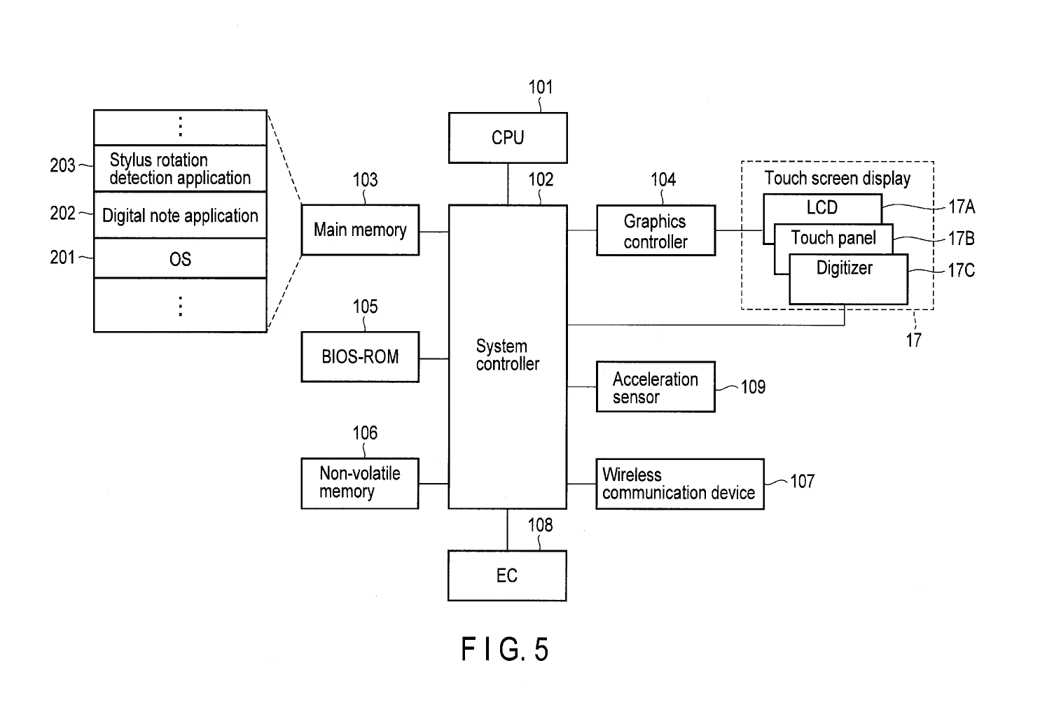

FIG. 5 illustrates a system configuration of the tablet computer 10.

The tablet computer 10 includes a CPU 101, a system controller 102, a main memory 103, a graphics controller 104, a BIOS-ROM 105, a non-volatile memory 106, a wireless communication device 107, an embedded controller (EC) 108, an acceleration sensor 109 and the like.

The CPU 101 is a processor configured to control operations of various modules in the tablet computer 10. The CPU 101 executes various computer programs loaded from a storage device, namely, the non-volatile memory 106 to the main memory 103. These programs include an operating system (OS) 201 and various application programs. The application programs include a digital note application program 202, a stylus rotation detection application program 203 and other application programs. Other application programs may be a web browser, photo/moving image/music reproduction application program and the like. The digital note application program 202 includes a function of creating and displaying the above-mentioned handwritten document, a function of editing the handwritten document, a stroke completion function and the like. The stylus rotation detection application program 203 is automatically activated when the digital note application program 202 and other application programs are activated. The stylus rotation detection application program 203 detects a rotation operation on the axis of a stylus when the stylus is in contact with or in proximity to the screen, and generates an event. The generated event is passed to the digital note application program and other application programs so as to be used as an instruction of predetermined processing or the like.

The CPU 101 executes a basic input/output system (BIOS) stored in the BIOS-ROM 105. The BIOS is a program for hardware control.

The system controller 102 is a device configured to connect a local bus of the CPU 101 and various other components. The system controller 102 includes a built-in memory controller configured to perform access control of the main memory 103. Further, the system controller 102 includes a function of performing communication with the graphics controller 104 via a serial bus conforming to the PCI Express standard or the like.

The graphics controller 104 is a display controller configured to control an LCD 17A used as a display monitor of the tablet computer 10. A display signal generated by the graphics controller 104 is transmitted to the LCD 17A.

The LCD 17A displays a screen image based on the display signal. The LCD 17A is provided with a touch panel 17B and a digitizer 17C thereon. The touch panel 17B is a capacitive pointing device for performing input on the screen of the LCD 17A. A contact position touched with a finger on the screen, the movement of the contact position and the like are detected by the touch panel 17B. The digitizer 17C is an electromagnetic induction pointing device for performing input on the screen of the LCD 17A. A contact position touched with the stylus 100 on the screen, the movement of the contact position and the like are detected by the digitizer 17C. The contact portion is detected by means of electromagnetic induction acting between a plurality of antenna coils running throughout the sensor board of the digitizer 17C and the stylus 100.

The stylus 100 is provided with a transmission coil, a power supply for the coil to continuously generate an alternating-current magnetic field therefrom, a driver, a writing pressure sensor and the like. The writing pressure sensor measures a pressure received when the stylus contacts with the touch screen display 17 and obtains writing pressure data. By modulating the alternating-current magnetic field generated by the transmission coil based on writing pressure data, the writing pressure data is transmitted from the stylus 100 to the digitizer 17C.

In the sensor board, a plurality of receiving antenna coils which receive the alternating-current magnetic field transmitted from the stylus 100 are arranged in the x-axis direction and the y-axis direction, respectively. The receiving antenna coils in the x-axis direction are selected in order, the receiving antenna coils in the y-axis direction are then selected in order, and thus the receiving levels of the respective receiving antenna coils are obtained. Since the receiving level of the antenna coil closest to the stylus 100 is at the highest and the receiving level gradually decreases as the antenna coil is located further, it is possible to identify by determining the receiving level the position of the tip of the stylus 100 in the x-y plane.

Note that the stylus 100 includes a built-in acceleration sensor and thus is capable of detecting an angle of rotation on the axis of the stylus. An angle of rotation is transmitted to the digitizer 17C similarly after the alternating-current magnetic field is modulated. The acceleration sensor is not limited to a triaxial sensor but may be biaxial. Further, it is possible to detect an angle of rotation not only by an accelerator sensor but also based on the synthesized signal of the signals from a plurality of sets of transmission antenna coils provided in the stylus 100.

The power supply of the stylus 100 may be a built-in battery in the stylus 100, but a built-in battery is not necessary if, by exchanging electromagnetic energy between the digitizer 17C and the antenna coil of the stylus 100, an alternating-current voltage is generated at the both ends of the antenna coil of the stylus 100 and the energy is stored to be used as a power supply.

The wireless communication device 107 is a device configured to establish wireless communication such as wireless LAN or 3G cellular. The tablet computer 10 is connected to the server 2 or the personal computer 1 by the wireless communication device 107 via the Internet or the like. The EC 108 is a single-chip microcomputer including an embedded controller for power control. The EC 108 includes a function of powering on or powering off the tablet computer 10 based on an operation of a power button by the user. The acceleration sensor 109 detects rotation of the screen of the touch screen display 17, and the graphics controller 104 rotates an image to be displayed on the LCD 17 accordingly to portrait or landscape format.

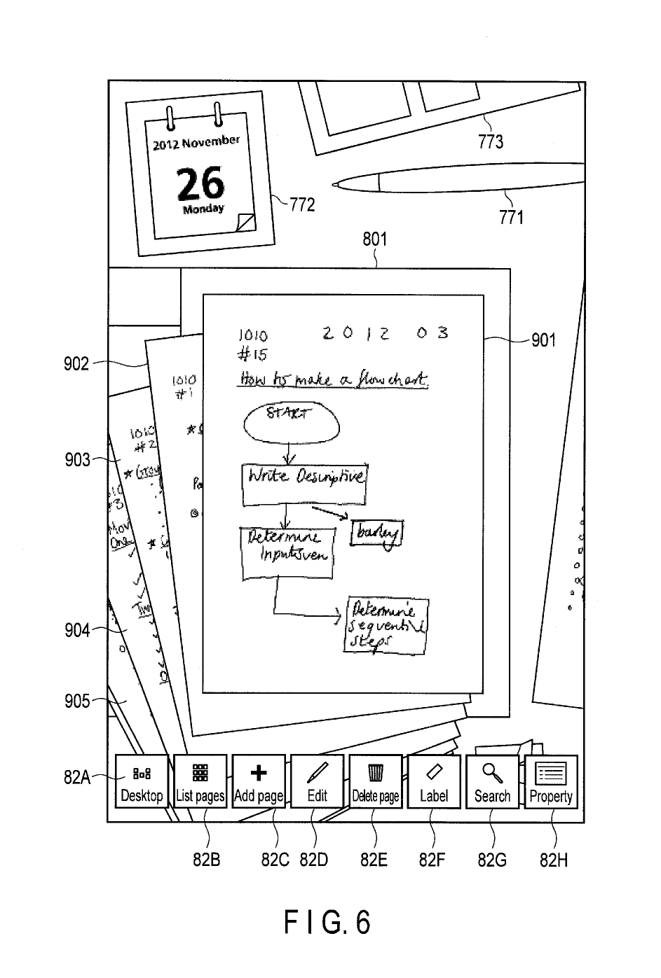

Next, an example of a screen image presented to the user by the digital note application program 202 will be described. When the digital note application program 202 is activated, a home screen image (not shown) is displayed. The home screen image is a basic screen image for handling a plurality of items of handwritten document data and is capable of performing the management of notes and the settings of the whole application. When a note icon is selected in the home screen image, a note preview screen image of the digital note corresponding to the note icon is displayed, as shown in FIG. 6. The note preview screen image is a screen image available for viewing any page of the selected digital note. The plurality of pages 901, 902, 903, 904 and 905 in the digital note are displayed in such a manner that these respective pages 901, 902, 903, 904 and 905 are at least partially visible and are overlapped with each other.

The note preview screen image further displays a menu in a bottom part of the screen. The menu includes a home button 82A, a page list button 82B, a page adding button 82C, a page editing button 82D, a page deleting button 82E, a label button 82F, a search button 82G and a property display button 82H. The home button 82A is a button for closing the preview of a note and displaying the home screen image. The page list button 82B is a button for displaying a list of pages in a digital note currently selected. The page adding button 82C is a button for creating (adding) a new page. The page editing button 82D is a button for displaying a page editing screen image. The page deleting button 82E is a button for deleting a page. The label button 82F is a button for displaying a list of types of available labels. The search button 82G is a button for displaying a search screen image. The property display button 82H is a button for displaying the property of the note. These menu buttons are selected by being touched with a finger or the stylus 100.

The stylus rotation detection application 203 generates an event based on a rotation operation of the stylus 100, and the digital note application 202 and other applications which received the event perform selection or the like of a menu button based on the event.

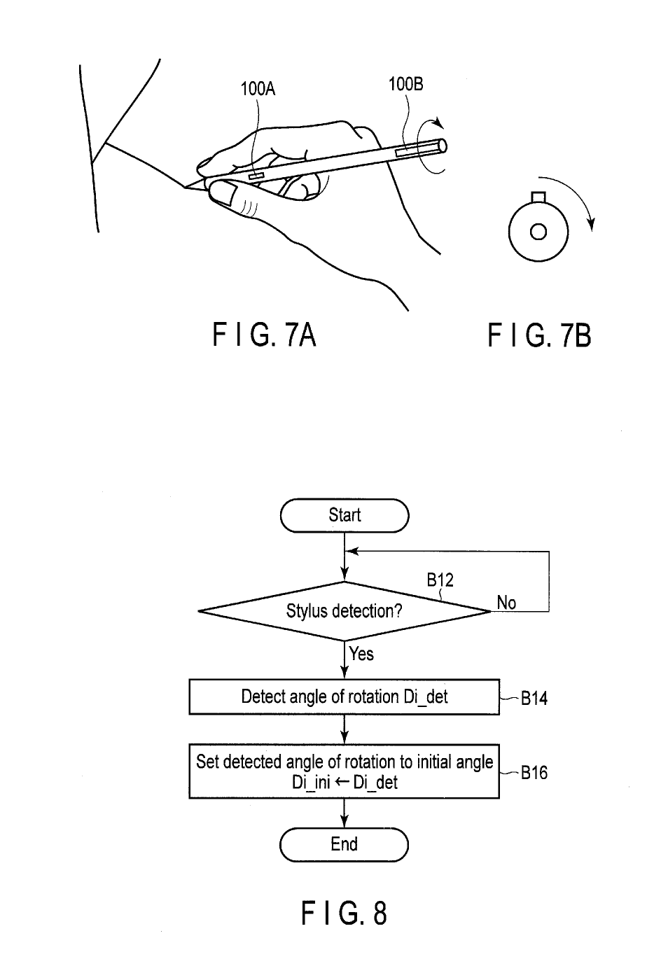

With reference to FIGS. 7A and 7B, the rotation operation of the stylus 100 used as an event generation trigger in the present embodiment will now be described. In a state shown in FIG. 7A, while holding the stylus 100, the user rotates the stylus 100 by a predetermined angle in a clockwise direction with the thumb and the forefinger. The predetermined angle is such an angle that the user can rotate the stylus 100 while the user keeps holding the stylus 100 without newly holding it again, for example, 90 degrees. When the angle is large, it is difficult for the user to rotate the stylus 100 while the user keeps holding it. In contrast, when the angle is small, even though the user is not intended to rotate the stylus 100, the rotation may be detected. Note that the rotation of a stylus is not limited to a case where the stylus is rotated while the position of the axis of the stylus remains unchanged but also includes a case where the stylus is rotated while the axis of the stylus changes such as a case where the stylus rolls on the surface of a finger.

The operation of the stylus rotation detection application 203 detecting such a rotation operation of the stylus 100 as shown in FIGS. 7A and 7B will now be described.

FIG. 8 is a flowchart showing the setting of an initial angle necessary for rotation detection. In block B12, whether or not the stylus 100 is in contact with or in proximity to the digitizer 17C is determined. When handwriting or stylus input is performed, the stylus 100 comes close to the digitizer 17C. This determination is performed in such a manner that the digitizer 17C detects the alternating-current magnetic field generated by the transmission antenna coil of the stylus 100. The processing of FIG. 8 is executed each time the stylus 100 comes close to the digitizer 17C.

When the stylus 100 is detected, in block B14, the angle of rotation of the stylus Di_det is detected. The angle may be detected by a built-in acceleration sensor in the stylus 100 and transmitted from the stylus 100 to the digitizer 17C, or if the stylus 100 does not comprise a built-in acceleration sensor, may be detected by the digitizer 17C by synthesizing the signals from two antenna coils embedded in the stylus 100.

In block B16, the detected angle Di_det is set as an initial angle Di_ini.

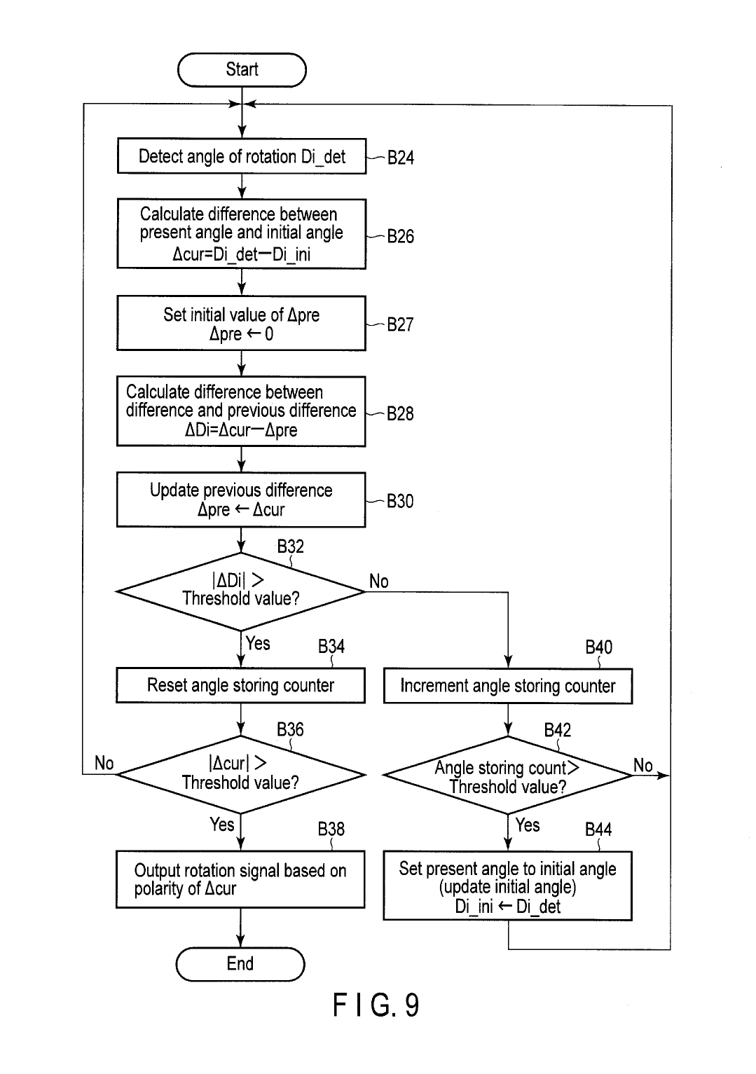

After the execution of FIG. 8, when one end portion of the stylus 100 is in contact with or in proximity to the display surface of the digitizer 17C, rotation detection processing shown in FIG. 9 is executed.

In block B24, the angle of rotation of the stylus Di_det is detected. In block B26, the difference Δcur (=Di_det-Di_ini) between the present angle Di_det and the initial angle Di_ini is calculated. In block B27, the initial value (=0) of the previous difference Δpre is set. In block B28, the difference ΔDi (=Δcur-Δpre) between the difference Lour and the previous difference Δpre is calculated. In block B30, the previous different Δpre is updated by Δcur.

The difference ΔDi between the difference Δcur and the previous difference Δpre is calculated to distinguish rotation intended by the user and unintended rotation caused by hand movement or the like. The difference of the differences of the rotation intended by the user varies. Therefore, it is determined in block B32 whether or not the absolute value of the difference ΔDi between the difference and the previous difference is a threshold value or more.

When it is the threshold value or more, it is possible to determine that the stylus is rotated intentionally by the user, and in block B34, an angle storing counter is reset. The angle storing counter is used for updating the initial angle, which will be described later.

In block B36, whether or not the absolute value of the difference Δcur between the present angle and the initial angle is a threshold value (for example, 90 degrees) or more is determined. When it is the threshold value or more, in block B38, a rotation signal based on the polarity of the difference Δcur is output. When the clockwise direction of the angle of rotation is defined to be positive, if the difference Δcur has positive polarity, it can be determined that clockwise rotation is performed, and if the difference Δcur has negative polarity, it can be determined that counterclockwise rotation is performed. In block B36, when the absolute value of the difference Δcur is determined to be less than the threshold, processing returns to block B24 to continue the detection of the angle of rotation. In this way, when the stylus is rotated by a predetermined angle or more in a predetermined direction on the axis of the stylus, a rotation signal based on the rotation direction is output. As mentioned above, the rotating of the stylus by a predetermined angle or more in the predetermined direction on the axis of the stylus includes a case where the stylus is rotated by the predetermined angle or more in the predetermined direction while the position of the axis of the stylus remains unchanged, and a case where the stylus is rotated by the predetermined angle or more in the predetermined direction while the axis of the stylus changes such as a case where the stylus rolls on the surface of a finger. These two types of rotation signals are passed to other applications, and in the applications, predetermined data is input. For example, in the digital note application, when a rotation signal is received, the pen type may be changed to a mechanical pencil, a ball-point pen, a fountain pen, a felt pen or the like, or the color line, the line thickness or the transparency may be changed. Further, in an application such as the web browser, photo reproduction, moving image reproduction and music reproduction application, when a rotation signal is received, processing for turning to the next page (previous page), turning to the next title (previous title), or speeding up (slowing down) the reproduction by one step may be performed.

In block B32, when the absolute, value of the difference ΔDi of the differences is determined to be less than the threshold value, the angle storing counter is incremented in block B40. The angle storing counter measures a period when the absolute value of the difference of the differences is less than the threshold value. The difference of the differences in the rotation intended by the user varies whereas the difference of the differences in other rotations does not change substantially.

In block B42, whether or not the value of the angle storing counter is a threshold value or more is determined. If it is the threshold value or more, this indicates a case where the stylus is rotated from the initial angle but is then not rotated much for a certain period or more, and thus in block B44, the initial angle is updated. That is, the detected angle (present angle) Di_det is set to the initial angle Di_ini. Subsequently, processing returns to block B24 to continue the detection of the angle of rotation. If it is determined in block B42 that the value of the angle storing counter is less than the threshold value, processing returns to the block B24 to continue the detection of the angle of rotation.

In the processing of FIG. 9, when the stylus 100 is rotated by a predetermined angle or more in a predetermined direction on the axis of the stylus 100 as shown in FIGS. 7A and 7B, this can be regarded as the performance of one rotation operation, and thus a rotation signal based on the rotation direction can be output. Other applications can execute predetermined processing based on the rotation signal. In this way, stylus input can be performed by such an easy operation as the rotation of the stylus, and consequently the user interface improves. Note that, if the time required for the rotation is predetermined time or more, the rotation is not regarded as a rotation operation for input, and therefore it is possible to distinguish slight rotation caused by hand movement or the like and a rotation operation intended by the user.

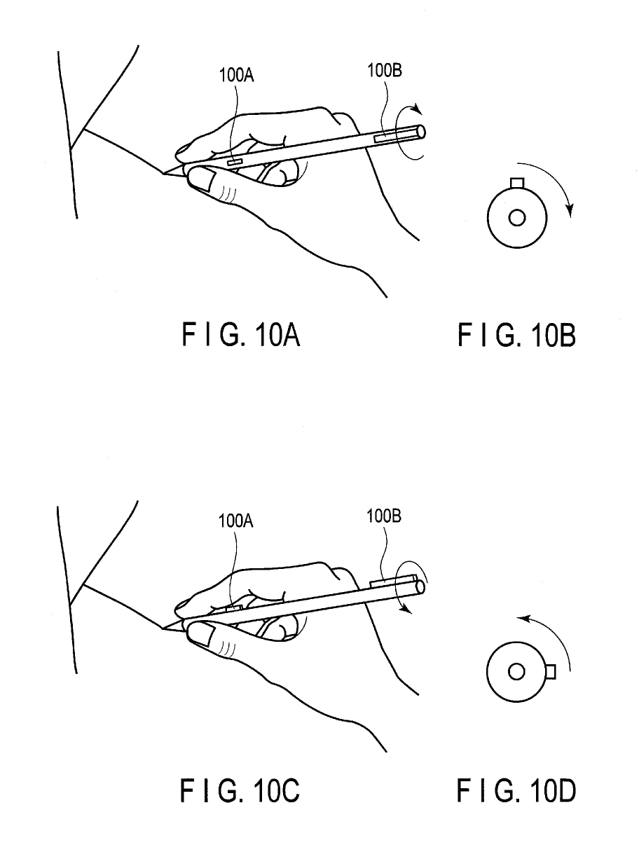

Next, another example of the rotation operation is described. In the example described above, a case where the stylus is rotated by a predetermined angle or more in a certain direction is detected as a stylus operation. However, during handwriting input in particular, the stylus is often returned to the original initial position after the stylus is rotated. Therefore, as shown in FIGS. 10A-10D, an example of detecting, as one stylus operation, a case where the stylus 100 is rotated by a first angle or more in the first direction on the axis of the stylus 100 and is then rotated by a second angle or more in the second direction substantially opposite to the first direction such that the angle of the stylus 100 returns to a substantially original angle, is described. In the state shown in FIGS. 10A and 10B, while holding the stylus 100, the user rotates it by a predetermined angle in a clockwise direction on the axis of the stylus 100 using mainly the thumb and the forefinger. The predetermined angle is such an angle that the user can rotate the stylus 100 while holding the stylus 100 without newly holding it again, for example, 90 degrees. When the angle is large, it is difficult for the user to rotate the stylus 100 while the user keeps holding it. In contrast, when the angle is small, even though the user is not intended to rotate the stylus 100, the rotation may be detected. After rotated, from the state shown in FIGS. 100 and 10D, the user rotates the stylus 100 by a predetermined angle in a counterclockwise direction while the user keeps holding it and returns it substantially to the state shown in FIGS. 10A and 10B. Note that it is not necessary to return the stylus 100 exactly to the original state but only necessary to rotate it by substantially the same angle clockwise and counterclockwise. If the stylus 100 is provided with a stylus button 100A or a clip 100B, by regarding its position as an indication, the user can rotate the stylus 100 in the first direction and then rotate the stylus 100 in the second direction so as to return it to the original position.

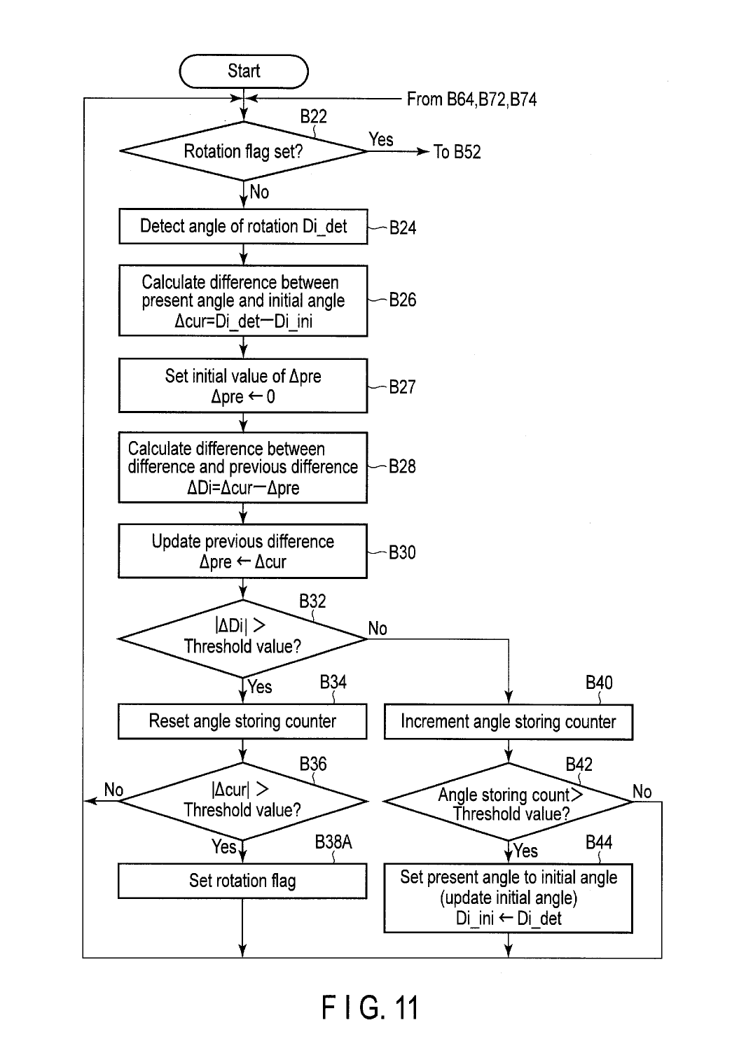

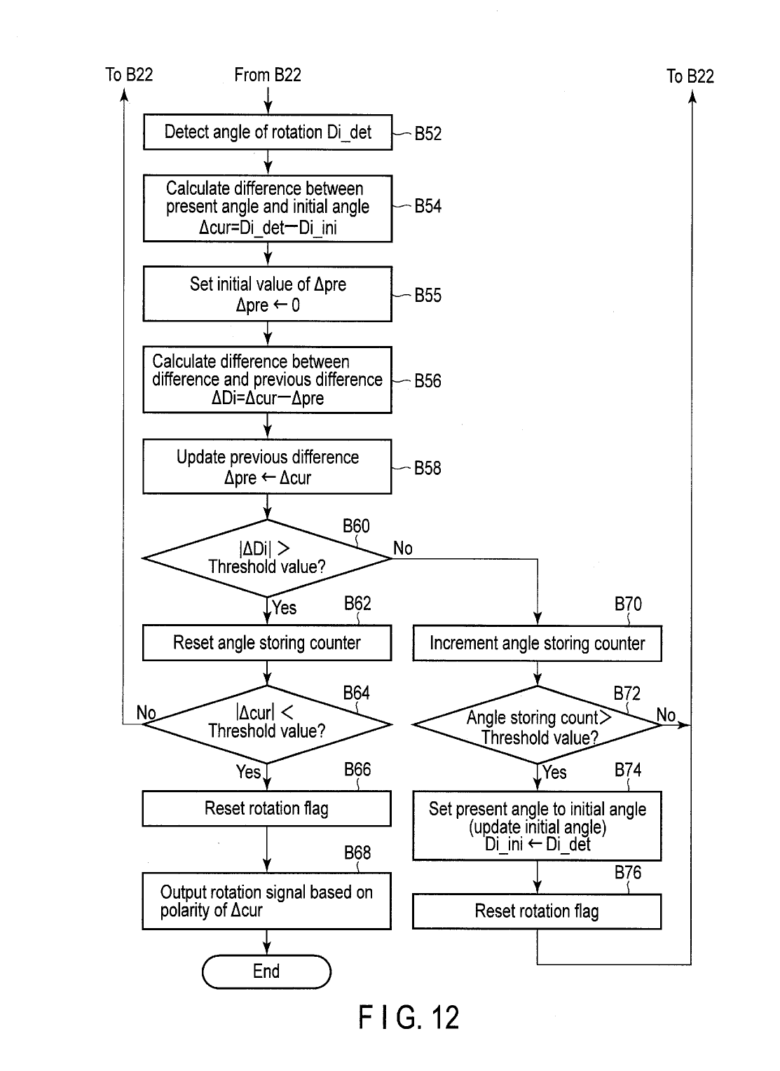

The operation of the stylus rotation detection application 203 detecting such a rotation operation of the stylus 100 as shown in FIGS. 10A-10D will now be described with reference to the flowcharts of FIGS. 11 and 12. As for the setting of the initial angle, the operation same as that of FIG. 8 is performed.

After the setting of the initial angle, when one end of the stylus 100 is in contact with or in proximity to the display surface of the digitizer 17C, the rotation detection processing shown in FIG. 11 is executed. The steps in the flowchart of FIG. 11 corresponding to those of FIG. 9 are denoted by the same reference numbers, and the detailed descriptions thereof are omitted.

In block B22, whether or not a rotation flag is set is determined. The rotation flag is set when the stylus is rotated by a predetermined angle or more in a predetermined direction, which will be described later, and thus it is possible to distinguish whether the rotation is a rotation performed from the initial state or a rotation for returning back to the initial state.

When the rotation flag is not set, the rotation can be regarded as a rotation performed at the initial state. In this case, in block B24, the angle of rotation of the stylus Di_det is detected. In block B26, the difference Δcur (=Di_det-Di_ini) between the present angle Di_det and the initial angle Di_ini is calculated. In block B27, the initial value (=0) of the previous difference Δpre is set. In block B28, the difference ΔDi (=Δcur-Δpre) between the difference Δcur and the previous difference Δpre is calculated. In block B30, the previous different Δpre is updated by Δcur.

The difference ΔDi between the difference Δcur and the previous difference Δpre is calculated to distinguish rotation intended by the user and unintended rotation caused by hand movement or the like. The difference of the differences of the rotation intended by the user varies. Therefore, it is determined in block B32 whether or not the absolute value of the difference ΔDi between the difference and the previous difference is the threshold value or more. When it is the threshold value or more, it is possible to determine that the stylus is rotated intentionally by the user, and in block B34, the angle storing counter is reset. The angle storing counter is used for updating the initial angle, which will be described later.

In block B36, whether or not the absolute value of the difference Δcur between the present angle and the initial angle is the threshold value (for example, 90 degrees) or more is determined. When it is the threshold value or more, it is determined that the stylus is rotated by a predetermined angle or more in the first direction, and in block B38, the rotation flag is set. Subsequently, processing returns to the block B22. In block B36, if the absolute value of the difference Δcur is determined to be less than the threshold value, processing returns to the block B22.

In block B32, when the absolute value of the difference ΔDi of the differences is determined to be less than the threshold value, the angle storing counter is incremented in block B40. The angle storing counter measures the period when the absolute value of the difference of the differences is less than the threshold value. The difference of the differences in the rotation intended by the user varies whereas the difference of the differences in other rotations does not change much.

In block B42, whether or not the value of the angle storing counter is the threshold value or more is determined. If it is the threshold value or more, this indicates a case where the stylus is not rotated much for a certain period or more, and thus in block B44, the initial angle is updated. That is, the detected angle (present angle) Di_det is set to the initial angle Di_ini. Subsequently, processing returns to block B22. If it is determined in block B42 that the value of the angle storing counter is less than the threshold value, processing returns to the block B22.

When it is determined in block B22 that the rotation flag is set, in block B52 of FIG. 12, the angle of rotation of the stylus Di_det is detected. In block B54, the difference Δcur (=Di_det-Di_ini) between the present angle Di_det and the initial angle Di_ini is calculated. In block B56, the difference ΔDi (=Δcur-Δpre) between the difference Δcur and the previous difference Δpre is calculated. In block B58, the previous different Δpre is updated by Δcur.

The difference ΔDi between the difference Δcur and the previous difference Δpre is calculated to distinguish rotation intended by the user and unintended rotation caused by hand movement or the like. The difference of the differences of the rotation intended by the user varies. Therefore, in block B60, whether or not the absolute value of the difference ΔDi between the difference and the previous difference is the threshold value or more is determined. When it is the threshold value or more, it is possible to determine that the stylus is rotated intentionally by the user, and in block B62, the angle storing counter is reset. The angle storing counter is used for updating the initial angle, which will be described later.

In block B64, whether or not the absolute value of the difference Δcur between the present angle and the initial angle is less than the threshold value (for example, 90 degrees) is determined. When it is less than the threshold value, it is determined that the stylus is rotated by a predetermined angle or more in the first direction and is then rotated by the predetermined angle or more in the second direction back to substantially the original state, and thus in block B66, the rotation flag is reset. Subsequently, in block B68, a rotation signal based on the polarity of the difference Δcur is output to end the processing. This is because depending on whether the stylus is rotated clockwise first (Δcur is positive) or counterclockwise first (Δcur is negative) a different rotation signal is output as a different operation. If it is determined in block B64 that the value of the angle storing counter is not less than the threshold value, processing returns to the block B22.

In block B60, when the absolute value of the difference ΔDi of the differences is determined to be less than the threshold value, in block B70, the angle storing counter is incremented. The angle storing counter measures the period when the absolute value of the difference of the differences is less than the threshold value. The difference of the differences in the rotation intended by the user varies, but the difference of the differences in other rotations does not change much.

In block B72, whether or not the value of the angle storing counter is the threshold value or more is determined. If it is the threshold value or more, this indicates a case where the stylus is rotated from the initial angle but is then not rotated much for a certain period or more, and thus in block B74, the initial angle is updated. That is, the detected angle (present angle) Di_det is set to the initial angle Di_ini. In block B76, the rotation flag is reset. Subsequently, processing returns to block B22. If it is determined in block B72 that the value of the angle storing counter is less than the threshold value, processing returns to the block B22.

In the processing of FIGS. 11 and 12, when the stylus 100 is rotated by the predetermined angle or more in the first direction from the initial angle and is then rotated by the predetermined angle or more in the second direction, a rotation signal based on the first direction can be output. Other applications can execute predetermined processing based on the rotation signal. Note that, if the time required for the rotation is predetermined time or more, the rotation is not regarded as a rotation operation for input, and therefore it is possible to distinguish slight rotation caused by hand movement or the like and a rotation operation intended by the user.

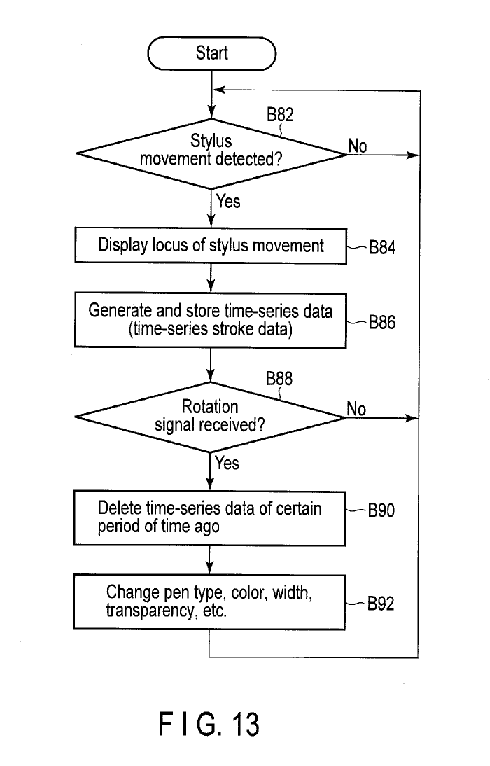

FIG. 13 is a flowchart showing an example of processing of the digital note application which detects a rotation signal from the stylus rotation detection application 203 and executes a predetermined operation. In block B82, whether or not the stylus is moving is determined. The movement of the stylus can be detected by the digitizer 17C by determining whether or not the position of the tip of the stylus in the x-y plane is changing. When the movement of the stylus is detected, the locus of the movement of the stylus is displayed on the LCD 17A in block B84. In block B86, such time-series data (time-series stroke data) as that of FIG. 3 is generated based on the series of coordinates corresponding to the locus of the movement of the stylus, and stored temporarily as handwritten page data.

In block B88, whether or not a rotation signal from the stylus rotation detection application 203 is received is determined. If the rotation signal is not received, processing returns to the block B82 to continue the detection of the movement of the stylus. If the rotation signal is received, the time-series data generated a certain time ago is deleted in block B90. This is because the movement of the stylus immediately before the reception of the rotation signal is intended for inputting data by a rotation operation and not intended for handwriting a character. Therefore, the time-series data generated during the rotation operation is deleted from where it is temporarily stored.

In block B92, the pen type may be changed to a mechanical pencil, a ball-point pen, a fountain pen, a felt pen or the like, or the color line, the line thickness or the transparency may be changed.

In the processing of FIGS. 11 and 12, when the stylus 100 is rotated by a predetermined angle or more from the initial angle as shown in FIGS. 10A-10D and is then rotated to about the original angle in the opposite direction, this can be regarded as the performance of one rotation operation. Based on whether the stylus is rotated clockwise first or the stylus is rotated counterclockwise first, it is possible to detect them differently as different rotation operations and to send two rotation operations by the to-and-fro rotation of the stylus to other applications, and consequently the user interface is improved. Note that, if the time required for the rotation is predetermined time or more, the rotation is not regarded as a rotation operation for input, and therefore it is possible to distinguish slight rotation caused by hand movement or the like and a rotation operation intended by the user. Since a rotation operation is detected once the stylus is back to the original state, if the user stops rotating the stylus in the middle, the rotation up to then will be ignored. Therefore, if the user changes his or her mind after rotating the stylus or if the user has rotated the stylus accidentally, all the user has to do is to stop rotating it without rotating it back to the original state.

As described above, in the present embodiment, it is possible to input predetermined data by detecting one rotation operation of the stylus. The rotation operation is not limited to a case where the stylus is rotated by a predetermined angle in a certain direction but also includes a case of a to-and-fro rotation operation where the stylus is rotated by a predetermined angle or more in the first direction and is then rotated by the predetermined angle or more in the second direction. Each time one rotation operation is performed, the processing assigned to the rotation operation (for example, changes of the pen type, the line color, the line thickness, the transparency, etc.) is performed. For example, when the processing assigned to the rotation operation is the pen type, the pen type is changed in a certain order (such as an order of mechanical pencil, ball-point pen, fountain pen, felt pen and mechanical pencil) each time one rotation operation is performed. When a rotation operation in the opposite direction is performed, the pen type changes in the opposite order. The processing assigned to the rotation operation may be changed by pushing the stylus switch 100A provided in the fore-end portion of the stylus. For example, each time the stylus switch 100A is pushed, the processing executed in response to the rotation operation may be changed in the order of the pen type, the line color, the line thickness, the transparency and the pen type, etc. In applications other than the digital note application, for example, in the web browser, photo reproduction, moving image reproduction and music reproduction application and the like, in response to the rotation operation, processing for turning to the next page (previous page), turning to the next title (previous title), or speeding up (slowing down) the reproduction by one step may be performed.

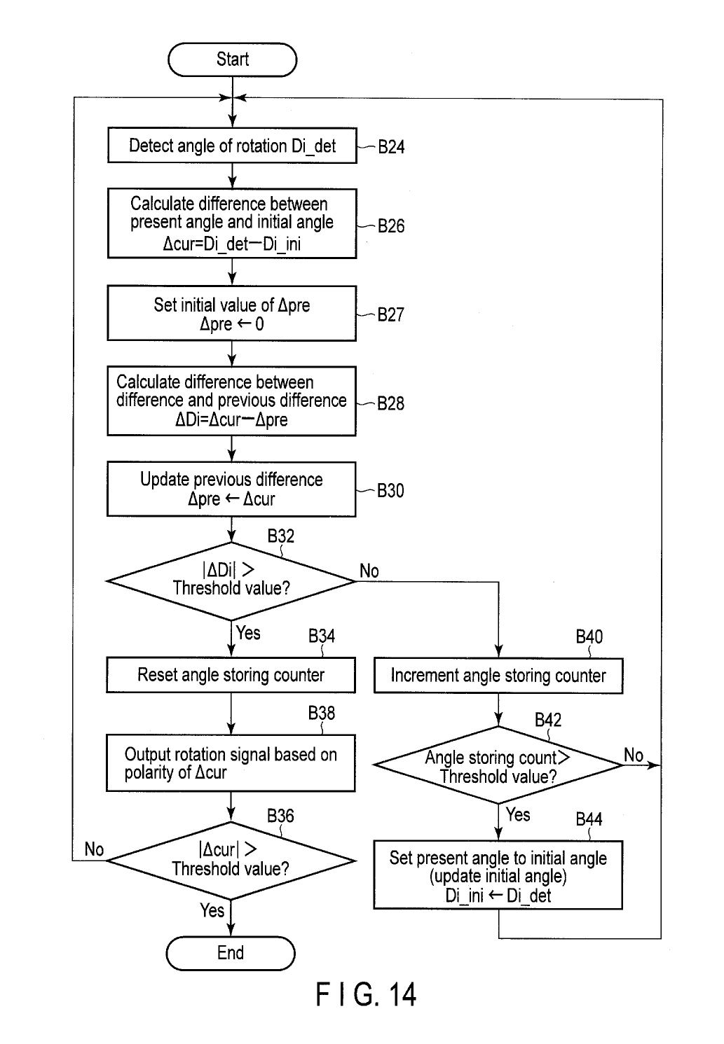

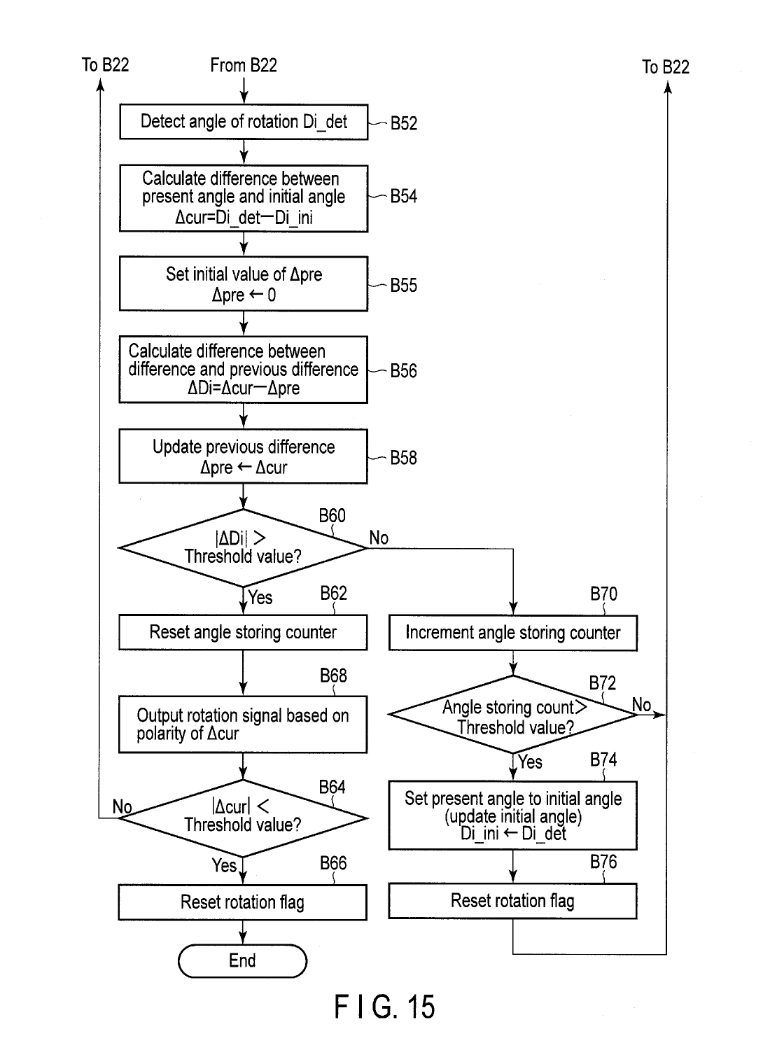

In the embodiment described above, one rotation signal is output each time one rotation operation is detected, but a plurality of rotation signals may be output during the rotation operation. For example, as shown in FIG. 14, by reversing, in the flowchart of FIG. 9, block 36 of comparing of the absolute value of Lour and the threshold value and block B38 of output of the rotation signal, it is possible to output a rotation signal a plurality of times while the stylus is rotated by a certain angle or more from the initial angle. Similarly, as shown in FIG. 15, by executing, in the flowchart of FIG. 12, block B68 of output of the rotation signal before block B64 of comparing of the absolute value of Δcur and the threshold value, it is possible to output a rotation signal a plurality of times while the stylus is rotated by a certain angle or more in the first direction from the initial angle and is then rotated by the certain angle or more in the second direction.

The period for outputting a rotation signal a plurality of times is not limited to a period when the stylus is rotated by a certain angle or more in the first direction (FIG. 14) and a period when the stylus is rotated by a certain angle or more in the first direction from the initial angle and is then rotated by the certain angle or more in the second direction (FIG. 15), but may be a period when the stylus button 100A of the stylus 100 contacted with fingers is on. In this way, in any period during the rotation operation of the stylus 100, by setting the stylus button 100A on, it is possible to output a rotation signal a plurality of times and to output a rotation signal even after the rotation operation ends.

The above-described processing executed at the time of the detection of a rotation operation relates to the selection of a certain item, but it is certain possible to perform processing other than the processing described above. For example, it is possible to apply to password input (by associating it with, for example, three clockwise rotations, five counterclockwise rotations or the like).

Since the processing of the present embodiment can be realized by a computer program, the effect similar to that of the present embodiment can be easily achieved simply by installing the computer program in a computer via a computer readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method executed by an electronic device operable by using a stylus, the method comprising executing a first process when rotation of a stylus around an axis of the stylus in a first direction exceeds a first angle in a state where a first end of the stylus is in contact with or in proximity to a display of the electronic device.

2. The method of claim 1, further comprising executing a second process when rotation of the stylus around the axis in the first direction exceeds the first angle and rotation of the stylus around the axis in a second direction opposite to the first direction exceeds a second angle in a state where the first end is in contact with or in proximity to the display of the electronic device.

3. The method of claim 2, further comprising executing a third process when rotation of the stylus around the axis in the second direction exceeds a third angle and rotation of the stylus around the axis in the first direction exceeds a fourth angle in the state where the first end is in contact with or in proximity to the display of the display surface.

4. The method of claim 1, wherein, when a period of time when an angle change amount of the rotation of the stylus remains in a predetermined range is longer than a first period, a rotation angle of the stylus is determined relative to the rotation angle of the stylus at the end of the first period.

5. The method of claim 1, further comprising executing a third process when rotation of the stylus around the axis in the first direction further exceeds the third angle after rotation of the stylus around the axis in the first direction exceeds the first angle to execute the first process.

6. The method of claim 1, wherein the electronic device is capable of handwriting input, and further comprising cancelling a character input by hand while the stylus is rotating.

7. An electronic device operable by using a stylus, the device comprising circuitry configured to execute a first process when rotation of a stylus around an axis of the stylus in a first direction exceeds a first angle in a state where a first end of the stylus is in contact with or in proximity to a display of the electronic device.

8. The electronic device of claim 7, wherein the circuitry is further configured to execute a second process when rotation of the stylus around the axis in the first direction exceeds the first angle and rotation of the stylus around the axis in a second direction opposite to the first direction exceeds a second angle in a state where the first end is in contact with or in proximity to the display of the electronic device.

9. The electronic device of claim 8, wherein the circuitry is further configured to execute a third process when rotation of the stylus around the axis in the second direction exceeds a third angle and rotation of the stylus around the axis in the first direction exceeds a fourth angle in the state where the first end is in contact with or in proximity to the display of the display surface.

10. The electronic device of claim 7, wherein, when a period of time when an angle change amount of the rotation of the stylus remains in a predetermined range is longer than a first period, a rotation angle of the stylus is determined relative to the rotation angle of the stylus at the end of the first period.

11. The electronic device of claim 7, wherein the circuitry is further configured to execute a third process when rotation of the stylus around the axis in the first direction further exceeds the third angle after rotation of the stylus around the axis in the first direction exceeds the first angle to execute the first process.

12. The electronic device of claim 7, wherein the electronic device is capable of a handwriting input, and the circuitry is further configured to cancel a character input by hand while the stylus is rotating.

13. A non-transitory computer readable medium storing a computer program of an electronic device capable of a stylus input, the computer program controlling the computer to execute functions comprising executing a first process when rotation of a stylus around an axis of the stylus in a first direction exceeds a first angle in a state where a first end of the stylus is in contact with or in proximity to a display of the electronic device.

14. The computer readable medium of claim 13, further comprising executing a second process when rotation of the stylus around the axis in the first direction exceeds the first angle and rotation of the stylus around the axis in a second direction opposite to the first direction exceeds a second angle in a state where the first end is in contact with or in proximity to the display of the electronic device.

15. The computer readable medium of claim 13, further comprising executing a third process when rotation of the stylus around the axis in the second direction exceeds a third angle and rotation of the stylus around the axis in the first direction exceeds a fourth angle in the state where the first end is in contact with or in proximity to the display of the display surface.

16. The computer readable medium of claim 13, wherein, when a period of time when an angle change amount of the rotation of the stylus remains in a predetermined range is longer than a first period, a rotation angle of the stylus is determined relative to the rotation angle of the stylus at the end of the first period.

17. The computer readable medium of claim 13, further comprising executing a third process when rotation of the stylus around the axis in the first direction further exceeds the third angle after rotation of the stylus around the axis in the first direction exceeds the first angle to execute the first process.

18. The computer readable medium of claim 13, wherein the electronic device is capable of handwriting input, and further comprising cancelling a character input by hand while the stylus is rotating.
